(19) United States
(12) Patent Application Publication
(10) Pub. No.: US 2010/0175328 A1
(43) Pub. Date: Jul. 15, 2010

(54) PROFILE SYSTEM FOR A SLIDING DOOR

(76) Inventor: Burkhard Hess, Hamburg (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/651,557

(22) Filed: Jan. 4, 2010

(30) Foreign Application Priority Data
Jan. 12, 2009 (DE) 10 2009 004 663.1
Feb. 5, 2009 (DE) 10 2009 007 636.0

(51) Int. Cl. E05D 15/06

(52) U.S. Cl. 49/404

(57) ABSTRACT

A profile system for a sliding door (10) with a surrounding frame (14) and a door panel (19). According to the invention, provision is made for the frame (14) to have a profile (30) and at least one strip (20, 21, 22, 23), for the strip (20, 21, 22, 23) to consist of a derived timber product, for the strip (20, 21, 22, 23) to have a slot (26) which is arranged on a side (31) of the strip (20, 21, 22, 23) which faces the door panel (19), for the profile (30) to be inserted into the slot (26) and retentively connected to the strip (20, 21, 22, 23), for the profile (30) to have a U-shaped section (35), wherein the U-shaped section (35) is constructed in its width so that it corresponds to the width of the slot (26) of the strip (20, 21, 22, 23), and for the door panel (19) to be inserted into the profile (30).

### STATEMENT OF RELATED APPLICATIONS

This patent application is based on and claims the benefit of German Patent Application No. 10 2009 004 663.1 having a filing date of 12 Jan. 2009 and German Patent Application No. 10 2009 007 636.0 having a filing date of 5 Feb. 2009, both of which are incorporated herein in their entireties by this reference.

### BACKGROUND OF THE INVENTION

1. Technical Field

The invention refers to a profile system for a sliding door with a surrounding frame and a door panel.

2. Prior Art

For the opening and closing of a component opening, sliding doors, which have at least one door leaf, are used. This door leaf is essentially constructed with a frame consisting of profiles and a door panel which is arranged in the frame.

In sliding doors, the frame of which consists entirely of metal, it is worthy of improvement, in the case of greater frame thicknesses, to optimize weight and at the same time to minimize the costs for the materials.

For development of the sliding doors, a sliding door is to be constructed which, with regard to the width of its frame, is variable and at the same time has adequate rigidity without unnecessarily increasing the weight.

### BRIEF SUMMARY OF THE INVENTION

For achieving this object, the invention is a sliding door with a surrounding frame and a door panel. Provision is therefore made for the frame to have a profile and at least one strip, for the strip to consist of a derived timber product, for the strip to have a slot which is arranged on a side of the strip which faces the door panel, for the profile to be inserted into the slot and retentively connected to the strip, for the profile to have a U-shaped section, wherein the U-shaped section is constructed in its width so that it corresponds to the width of the slot of the strip, and for the door panel to be inserted into the profile.

With the solution according to the invention it is advantageous that larger frame widths can be achieved by using derived timber products without excessively increasing the weight, furthermore an adequate stability and rigidity of the door is achieved by using the profile which is connected in a fixed manner to the derived timber product. Moreover, by using the strip a large design clearance for the frame results.

It is understood that the invention can also be used with sliding windows or the like. In this respect, the term sliding door is generally used, wherein windows are also covered by this.

By the provision of an essentially fastening means-free connection between profile and strip consisting of derived timber product the weight optimization advantage is also maintained. This is further improved by the provision of profiled sections on the profile.

Since in the case of derived timber products with decorative top surfaces the edges can be more difficult to machine, by the provision of visible faces which are connected directly to the profile, this machining problem is preferably eliminated since the edges are covered in the milling region. The same applies to the provision of cover elements.

Further details of the invention result from the dependent claims and otherwise from the description.

### BRIEF SUMMARY OF THE DRAWINGS

A preferred exemplary embodiment of the invention is subsequently explained in more detail with reference to the drawing. In this drawing:

FIG. 1 shows a front view of a sliding door according to the invention with a profile system according to the invention,

FIG. 2 shows an exploded view of a sliding door according to FIG. 1,

FIG. 3 shows an exploded view of a frame element, according to the invention, of the sliding door according to FIG. 1,

FIG. 4 shows a side view of a profile, according to the invention, of a sliding door according to FIG. 1,

FIG. 5 shows a vertical sectional view through a sliding door according to FIG. 1 with a further sliding door, which is arranged parallel to it, according to FIG. 1, and

FIG. 6 shows a horizontal sectional view through a sliding door according to FIG. 1 with a further sliding door, which is arranged parallel to it, according to FIG. 1, similar to FIG. 5.

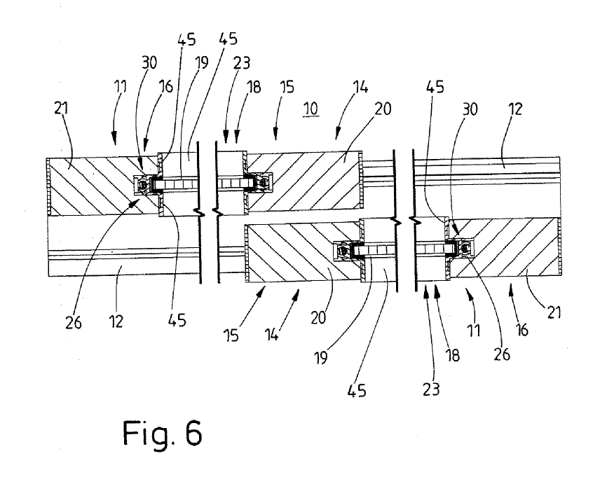

### DETAILED DESCRIPTION OF PREFERRED EMBODIMENTS

Sliding doors, like the sliding door 10 according to the invention, are used for closing off a component opening, which is not shown.

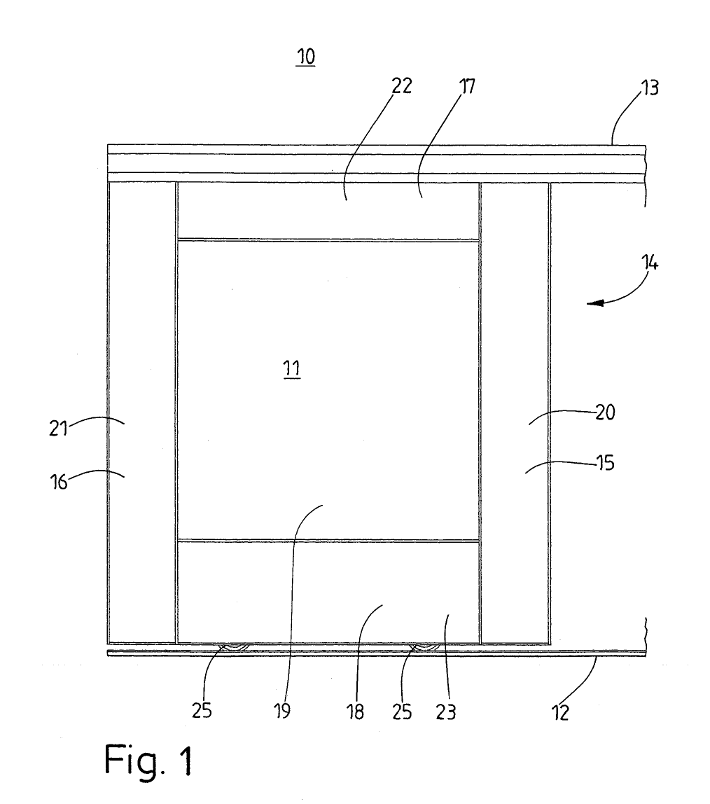

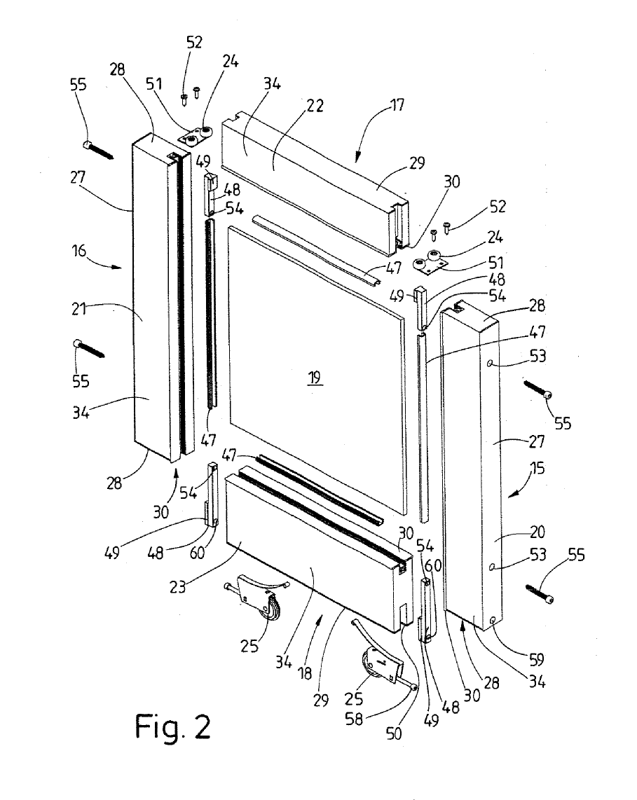

The sliding door 10 in the present exemplary embodiment comprises a door leaf 11 (FIGS. 1, 2). The door leaf 11 is movably mounted along a lower running rail 12 and an upper running rail 13. The door leaf 11 has a frame 14. The frame 14 is formed by vertical profiles 15, 16 and also horizontal transverse profiles 17, 18. In addition, the frame 14 has a panel 19. The vertical profiles 15, 16 and the transverse profiles 17, 18 preferably have strips 20, 21, 22, 23 consisting of a derived timber product, composite material or solid wood.

The door leaf 11 is guided in the upper running rail 13 by means of horizontally oriented running rollers 24 which are arranged in the region of the upper side of the frame 14. On the underside, the door leaf 11 by means of running rollers 25 rests on a base surface, for example on the lower running rail 12.

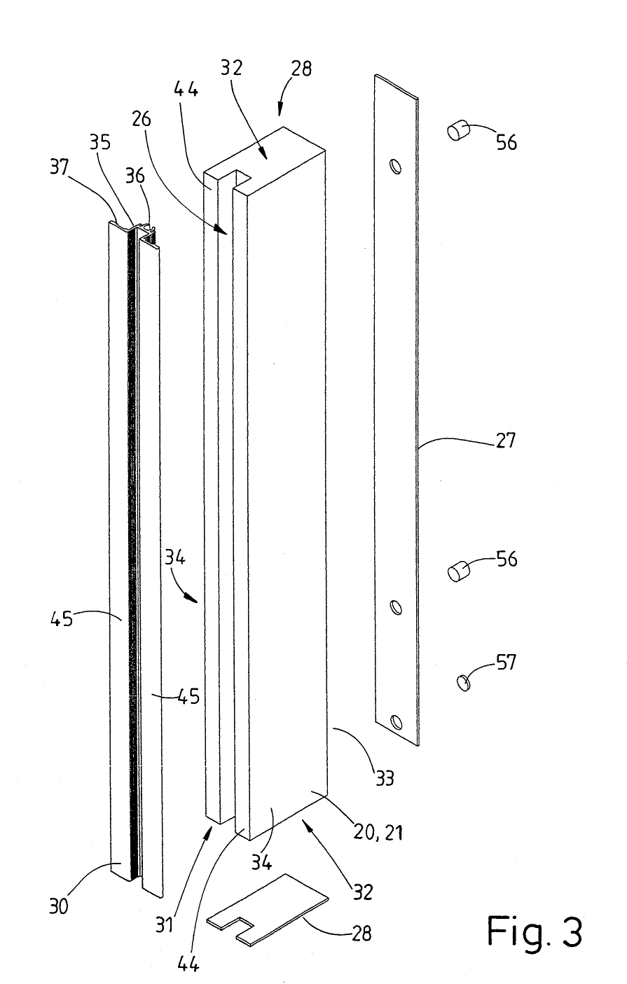

The strips 20, 21, 22, 23, on the inner side 31 which faces the door panel 19, are provided with a slot 26 (FIG. 3). The top/bottom side 32 and the rear side 33 are provided with a cover element 27, 28, 29 which also functions as a visible element and at the same time covers the material sides of the strips 20, 21, 22, 23. The visible sides 34 of the strips 20, 21, 22, 23 are for example covered with a veneer or a colored upper surface.

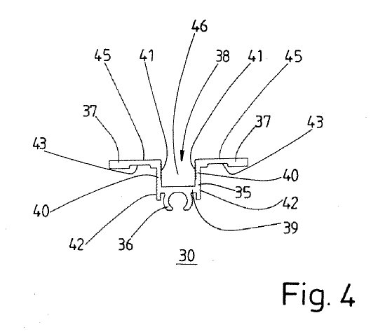

The profile 30 (FIG. 4) has a U-shaped section 35, a C-shaped section 36 which is arranged beneath the U-shaped section 35, and two legs 37 which are arranged at a right angle from the upper end 38 of the U-shaped section 35 parallel to the underside 39 of the U-shaped section 35. The walls 40 of the U-shaped section 35, which point upwards towards the open end 38, are provided in each case with a profiled section 41, 42 on their inner side and outer side, wherein the profiled section 42 which is arranged on the outer side effects a connection, which is constructed as toothing, to the slot 26. Provision is made on the underside of the legs 37 for recesses 43, to which adhesive is applied in order to create a connection to the surfaces 44 next to the slot 26 on the inner side 31 of the strips 20, 21, 22, 23. The upper side of the legs 37 serves as a visible face 45.

The walls 40 and the underside 39 form a space 46 into which an edging profile 47 is inserted. The door panel 19, which can be constructed as glass or as a panel consisting of a derived timber product, is inserted into this edging profile 47. A fastening element 48 is also inserted into the space 46, via which a better connection between the strips 20, 21, 22, 23 is achieved. The fastening element 48 on one side has a retaining section 49 which in the exemplary embodiment engages in a slot 50 in a side section of the horizontal strips 22, 23.

The rollers 25 are then inserted on the underside into the slot 50 which can also be constructed in an elongated manner on the underside of the horizontal strips 22, 23. The rollers 25 are fastened by means of a screw 58 which is inserted through a hole 60 in the fastening element 48 and through a hole 59 in the strips 20, 21. The screw 58 is then covered by a blanking plug 57. For the guiding in the upper running rail 13, the rollers 24 are arranged on a plate 51 which is screwed down with screws 52 onto the frame 14.

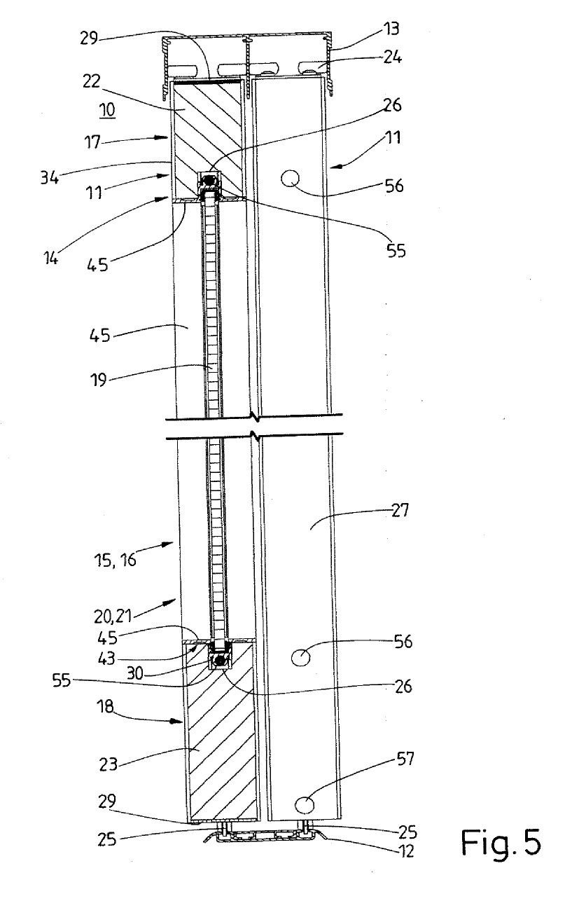

For interconnecting the strips 20, 21, 22, 23, screws 55 are inserted through the holes 53 in the strips 20, 21 and in the holes 54 in the fastening elements 48 and screwed into the C-shaped section 36 of the profile 30 (FIG. 5), as a result of which a retentively connection between the strips 20, 21, 22, 23 ensues and the frame 14 is formed. The screws 55 and the holes 53 are then covered by blanking plugs 56.

For installing the door leaf 11, the edging profiles 47 are first of all inserted into the profiles 30 which are applied with adhesive and inserted into the slots 26 of the strips 20, 21, 22, 23. The horizontal strips 22, 23 are then mounted onto the door panel 19 and clamped. The retaining sections 49 of the fastening elements 48 are then inserted into the lateral slots 50 of the strips 22, 23, the vertical strips 20, 21 are mounted onto the door panel 19 and onto the fastening elements and screwed down with the screws 55, as previously described. The rollers 24, 25 are then installed and the blanking plugs fitted. The rollers 24, 25 of the sliding door 10 which is produced in this way are then inserted into the running rails 12, 13 and the sliding door 10 is ready to use.

### LIST OF DESIGNATIONS

10 Sliding door
11 Door leaf
12 Lower running rail
13 Upper running rail
14 Frame
15 Vertical profile
16 Vertical profile
17 Horizontal profile
18 Horizontal profile
19 Door panel
20 Strip
21 Strip
22 Strip
23 Strip
24 Running roller
25 Running roller
26 Slot
27 Cover element
28 Cover element
29 Cover element
30 Profile
31 Inner side
32 Bottom/top side
33 Rear side
34 Visible face
35 U-shaped section
36 C-shaped section
37 Leg
38 Open end
38 Underside
40 Wall
41 Profiled section
42 Profiled section
43 Recess
44 Surface
45 Visible face
46 Space
47 Edging profile
48 Fastening element
49 Retaining section
50 Slot
51 Plate
52 Screw
53 Hole
54 Hole
55 Screw
56 Blanking plug
57 Blanking plug
58 Screw
59 Hole
60 Hole

What is claimed is:

1. A profile system for a sliding door with a surrounding frame and a door panel, wherein the frame (14) has a profile (30) and at least one strip (20, 21, 22, 23), and wherein the strip (20, 21, 22, 23) consists of a derived timber product, and the strip (20, 21, 22, 23) has a slot (26) which is arranged on a side (31) of the strip (20, 21, 22, 23) which faces the door panel (19), and wherein the profile (30) is inserted into the slot (26) and retentively connected to the strip (20, 21, 22, 23), wherein in addition the profile (30) has a U-shaped section (35), and the U-shaped section (35) is constructed in its width so that it corresponds to the width of the slot (26) of the strip (20, 21, 22, 23), and wherein the door panel (19) is inserted into the profile (30).

2. The profile system according to claim 1, wherein the derived timber product is chipboard, MDF, wood core plywood and/or a wood-plastic composite.

3. The profile system according to claim 1, wherein the profile (30) is produced from metal and/or plastic.

4. The profile system according to claim 1, wherein the retentitive connection of the profile (30) to the strip (20, 21, 22, 23) is an adhesive bond, a clamped connection, a screwed connection and/or a plug-in connection.

5. The profile system according to claim 1, wherein the U-shaped section (35) has a profiled top surface (41, 42) on at least one inner face and/or on at least one outer face.

6. The profile system according to claim 1, wherein the profile (30) has two legs (37) which are fastened on the U-shaped section (35), and fastened at an angle which is essentially a right angle on the upwardly open end (38) of the U-shaped section (35).

7. The profile system according to claim 6, wherein the underside of the legs (37) has a recess (43) for receiving adhesive.

8. The profile system according to claim 6, wherein the upper side of the legs (37) forms a visible face (45) of the profile (30) in relation to the frame (14).

9. The profile system according to claim 1, wherein the profile (30), beneath the underside (39) of the U-shaped section (35), has an essentially C-shaped section (36), the open region of which is arranged parallel to the underside (36) of the U-shaped section (35).

10. The profile system according to claim 8, wherein the C-shaped section (36) is suitable for accommodating a fastening means (55).

11. The profile system according to claim 1, wherein provision is made for a connecting element (48) which can be inserted into the profile (30) on a respective outer edge.

12. The profile system according to claim 11, wherein the connecting element (48) has a retaining section (49) which is arranged opposite the region of the connecting element (48) which engages in the profile (30), wherein the retaining section (49) engages in a retaining slot (50) of the strip (23) which is arranged essentially at a right angle to the profile.

13. The profile system according to claim 10, wherein the fastening means (55) is a screw.

14. A sliding door with a surrounding frame and a door panel, wherein the sliding door (10) has a profile system wherein the frame (14) has a profile (30) and at least one strip (20, 21, 22, 23), and wherein the strip (20, 21, 22, 23) consists of a derived timber product, and the strip (20, 21, 22, 23) has a slot (26) which is arranged on a side (31) of the strip (20, 21, 22, 23) which faces the door panel (19), and wherein the profile (30) is inserted into the slot (26) and retentively connected to the strip (20, 21, 22, 23), wherein in addition the profile (30) has a U-shaped section (35), and the U-shaped section (35) is constructed in its width so that it corresponds to the width of the slot (26) of the strip (20, 21, 22, 23), and wherein the door panel (19) is inserted into the profile (30).

15. The sliding door according to claim 14, wherein the profile (30) has two legs (37) which are fastened on the U-shaped section (35), and fastened at an angle which is essentially a right angle on the upwardly open end (38) of the U-shaped section (35).

16. The sliding door according to claim 14, wherein the profile (30), beneath the underside (39) of the U-shaped section (35), has an essentially C-shaped section (36), the open region of which is arranged parallel to the underside (36) of the U-shaped section (35).

17. The sliding door according to claim 14, wherein provision is made for a connecting element (48) which can be inserted into the profile (30) on a respective outer edge.
